(19) United States
(12) Patent Application Publication
(10) Pub. No.: US 2025/0392681 A1
(43) Pub. Date: Dec. 25, 2025

(54) DYNAMIC VIDEO QUALITY MANAGEMENT FOR STREAMING STORAGE SYSTEMS

(71) Applicant: Dell Products L.P., Round Rock, TX (US)

(72) Inventors: Raúl Gracia-Tinedo, Barcelona (ES); Yi Liu, Nanjing (CN)

(21) Appl. No.: 18/750,092

(22) Filed: Jun. 21, 2024

(51) Int. Cl. H04N 7/18

(52) U.S. Cl. CPC H04N 7/18

(57) ABSTRACT

A method for managing a video quality includes monitoring an input-output metric of a streaming storage system configured to receive and process video data. The method also includes making a first determination that the input-output metric does not comply with a set of video quality SLAs associated with the streaming storage system. The method further includes in response to the first determination, making a second determination, based on the input-output metric and the set of video quality SLAs, an adjusted set of video quality attributes. In addition, the method includes in response to the second determination, adjusting a set of video data received by a video analytics service using the adjusted set of video quality attributes.

### BACKGROUND

Streaming applications are applications that deal with a large amount of data arriving continuously. In processing streaming application data, the data can arrive late, arrive out of order, and the processing can undergo failure conditions. It can be appreciated that tools designed for previous generations of big data applications may not be ideally suited to process and store streaming application data.

### SUMMARY

In general, embodiments described herein relate to a method for managing a video quality, the method includes receiving, at an orchestrator of a streaming storage system, a set of video quality service level agreements (SLAs) associated with the streaming storage system and a video recording device. The method also includes receiving, at the orchestrator, a set of current video quality attributes associated with the video recording device. The method further includes monitoring, via the orchestrator, an input-output metric of the streaming storage system configured to receive and process video data from the video recording device. Moreover, the method includes making, by the orchestrator, a first determination that the input-output metric does not comply with the set of video quality SLAs. In addition, the method includes in response to the first determination, determining, by the orchestrator, an adjusted set of video quality attributes for the video recording device and based on the input-output metric, the set of video quality SLAs, and the current set of video quality attributes. Further, the method includes adjusting, using the orchestrator, a set of video data from the video recording device that is received by a video analytics service using the adjusted set of video quality attributes.

In general, embodiments described herein relate to a method for managing a video quality, the method includes monitoring an input-output metric of a streaming storage system configured to receive and process video data. The method also includes making a first determination that the input-output metric does not comply with a set of video quality SLAs associated with the streaming storage system. The method further includes in response to the first determination, making a second determination, based on the input-output metric and the set of video quality SLAs, an adjusted set of video quality attributes. In addition, the method includes in response to the second determination, adjusting a set of video data received by a video analytics service using the adjusted set of video quality attributes.

In general, embodiments described herein relate to a method for managing a video quality, the method includes receiving, at an orchestrator of a streaming storage system, a set of video quality SLAs associated with the streaming storage system and a video recording device. The method also includes receiving, at the orchestrator, a set of current video quality attributes associated with the video recording device. The method further includes monitoring, via the orchestrator, an input-output metric of the streaming storage system configured to receive and process video data from the video recording device. In addition, the method includes storing, using the orchestrator, a historical information set that includes multiple input-output metrics of the streaming storage system over a period of time, where the historical information set is obtained during the monitoring. Moreover, the method includes determining, by the orchestrator, a scheduled set of video quality attributes based on the historical information set. Further, the method includes adjusting, using the orchestrator, a second set of video data from the video recording device that is received by the video analytics service using the scheduled set of video quality attributes.

Other aspects of the embodiments disclosed herein will be apparent from the following description and the appended claims.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1 shows a diagram of a system in accordance with one or more embodiments disclosed herein.

FIG. 2 shows a diagram of a streaming storage system in accordance with one or more embodiments disclosed herein.

FIG. 3 shows a diagram of an orchestrator in accordance with one or more embodiments disclosed herein.

FIG. 4 shows a method for dynamic video quality management in accordance with one or more embodiments disclosed herein.

FIG. 5 shows a method for dynamic video quality management in accordance with one or more embodiments disclosed herein.

FIG. 6 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

Over the years, event storage systems (or streaming storage services/systems) (e.g., Apache Kafka, Apache Pulsar, Dell Pravega, etc.) are becoming increasingly popular to manage and store data events in different scenarios (e.g., Internet of Things (IoT), telecommunication, Edge deployments, etc.). These systems allow users/customers to write small events with low-latency and read events back both in real-time and batch for processing. In this manner, streaming storage systems are becoming increasingly used across the industry.

In most cases, streaming storage systems share a common goal, which is allowing applications to reliably store and read data with high-performance. To this end, such systems allow multiple writers and readers to work in parallel on a given topic (or stream). When reading a stream, most streaming storage systems provide the notion of a reader group (or consumer group). This abstraction allows one or more distributed reader processes to coordinate the task of reading stream events (e.g., the consumption of data from a set of readers across one or more stream events (or streams)) in a consistent manner (e.g., avoid missing events, avoid reading an event twice within a reading group, etc.) and balance the workload across readers (in the reader group). Normally, the distribution of a reading process (across readers) is based on how stream partitions/segments are distributed across readers.

However, analyzing data streams that, by their nature, consume a relatively large amount of system resources (e.g., providing data analytics for video streams), have a higher probability of saturating the available resources, especially in environments that are not able to easily expand the amount of available resources, such as an edge environment. In a video analytics scenario, saturation of the available resources can negatively impact one or more of the video data quality requirements, such as latency or resolution that may be crucial for video analytics that rely on timely data analysis.

For at least the reasons discussed above an approach to dynamically adjust video data stream quality that also operates in a manner that does not consume too much of the resources being preserved is needed.

Embodiments disclosed herein relate to methods and systems for dynamic video quality management for streaming storage systems. As a result of the processes discussed below, one or more embodiments disclosed herein advantageously provide (i) a reduction in saturation of streaming storage system resources which, in turn, improves the video data quality attributes, such as resolution and latency, (ii) enable a user to prioritize certain video data streams, and (iii) analyze and provide proactive adjustments to video data streams to thereby provide the above benefits without further involvement of a user.

The following describes various embodiments disclosed herein.

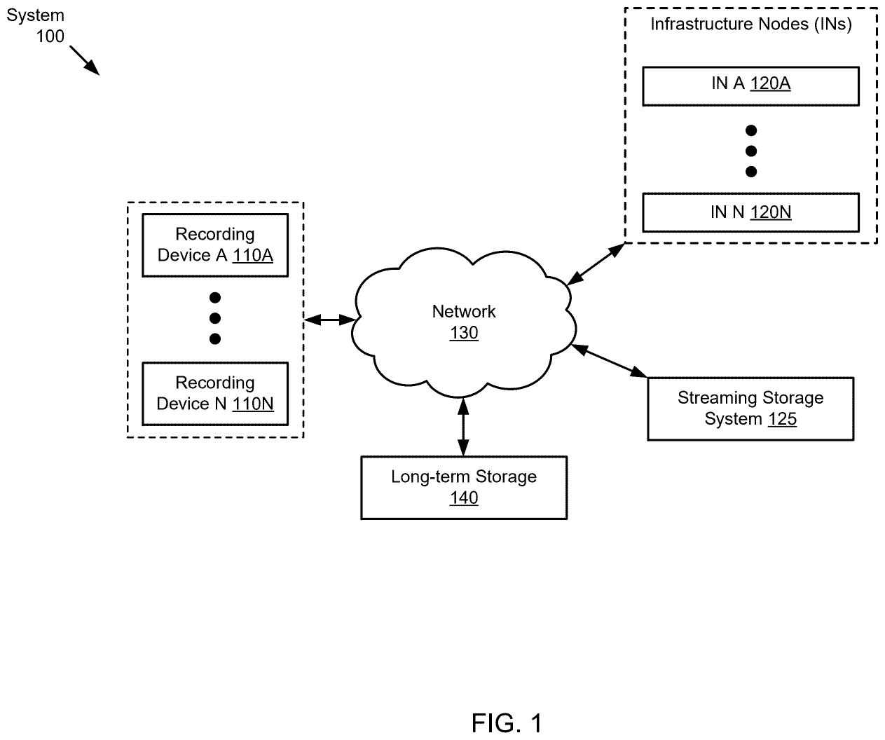

FIG. 1 shows a diagram of a system (100) in accordance with one or more embodiments disclosed herein. The system (100) includes any number of recording devices (e.g., recording devices A (110A), recording devices N (110N), etc.), a network (130), any number of infrastructure nodes (INs) (e.g., 120), a streaming storage system (125), and a long-term storage (140) (e.g., a tier-2 storage). The system (100) may facilitate the management of stream data from any number of sources (e.g., 110A, 110N, etc.). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the recording devices (e.g., 110A, 110N, etc.), the IN (120), the network (130), the streaming storage system (125), and the long-term storage (140) may be (or may include) physical hardware or logical devices, as discussed below. While FIG. 1 shows a specific configuration of the system (100), other configurations may be used without departing from the scope of the embodiments disclosed herein. For example, although the recording devices (e.g., 110A, 110N, etc.), the IN (120), the streaming storage system (125), and the long-term storage (140) are shown to be operatively connected through a communication network (e.g., 130), the recording devices (e.g., 110A, 110N, etc.), the IN (120), the streaming storage system (125), and the long-term storage (140) may be directly connected (e.g., without an intervening communication network) and/or connected through the communication network (130) in any combination. Further, in one or more embodiments, the recording devices (e.g., 110A, 110N, etc.) and the streaming storage system (125) are connected in a manner considered to be an edge environment that includes a combination of direct connections and/or connections over a local area network (LAN).

Further, the functioning of the recording devices (e.g., 110A, 110N, etc.) and the IN (120) is not dependent upon the functioning and/or existence of the other components (e.g., devices) in the system (100). Rather, the recording devices and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data) (including multiple events, each of which is associated with a routing key) that is continuously produced by streaming data sources (e.g., video recording devices, writers, clients, etc.), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

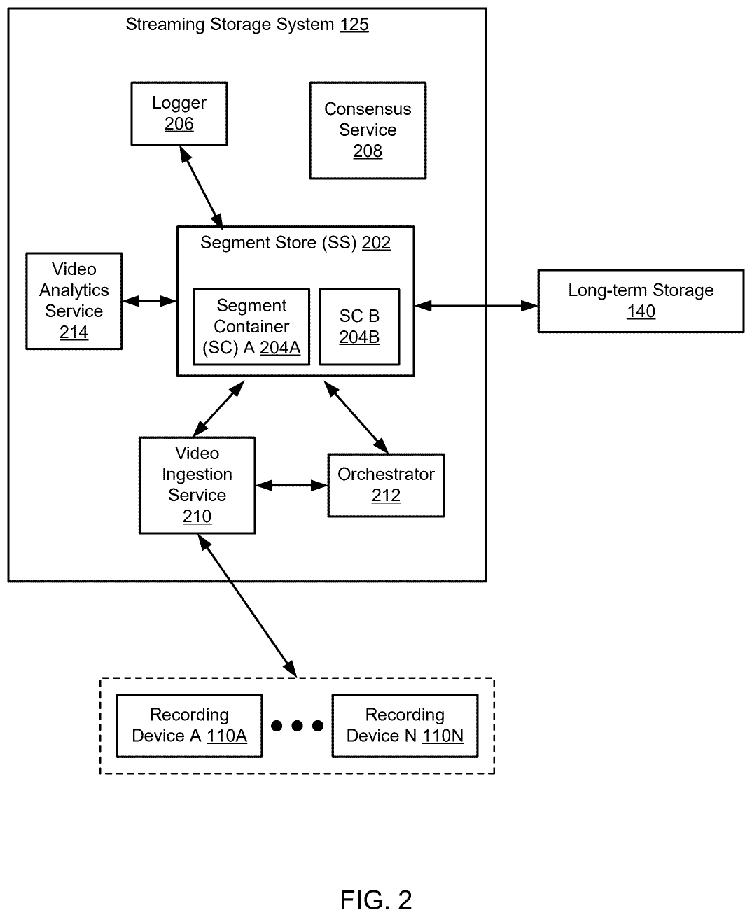

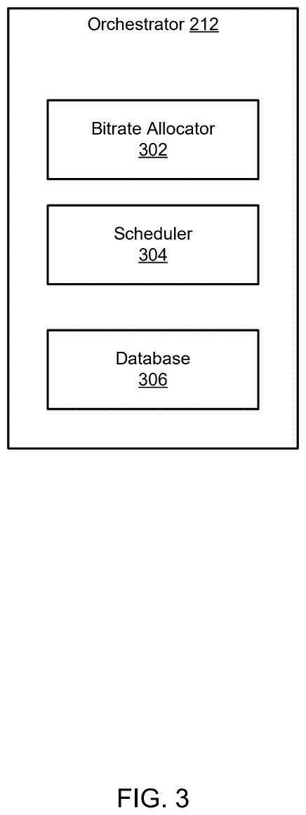

In one or more embodiments, the system (100) may be a distributed system (e.g., a data processing environment for processing streaming application data) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of recording devices (e.g., 110A, 110N, etc.). For example, the system (100) may be configured to organize unbounded, continuously generated data into a data stream (described below in reference to FIG. 2) that may be auto-scaled based on individual segment loading. The system (100) may also represent a comprehensive middleware layer executing on computing devices (e.g., 300, FIG. 3) that supports application and storage environments.

In one or more embodiments, a recording device (e.g., 110A, 110N, etc.) includes functionality to capture video data (e.g., a video recording device) relating to electromagnetic waves primarily in the infrared, visible, and ultraviolet spectrums. However, it should be appreciated that video data relating to the other electromagnetic spectrums may also be captured by the recording devices (e.g., 110A, 110N, etc.) without departing from the disclosure provided herein. Further, in one or more embodiments, the recording devices (e.g., 110A, 110N, etc.) may include functionality to, e.g.,: (i) capture sensory input (e.g., sensor data) in the form of text, audio, video, touch or motion, (ii) collect massive amounts of data at the edge of an IoT network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (120)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the recording devices may perform other functionalities without departing from the scope of the embodiments disclosed herein.

In one or more embodiments, the recording devices (e.g., 110A, 110N, etc.) may be geographically distributed devices (e.g., user devices, front-end devices, etc.) and may have relatively restricted hardware and/or software resources when compared to the IN (120). For example, the recording devices (e.g., 110A, 110N, etc.) form a closed-circuit television system (CCTV) across a geographically distributed area. As being, for example, a sensing device, each of the recording devices may be adapted to provide monitoring services. For example, a client may monitor the state of a scene (e.g., objects disposed in a scene). The monitoring may be performed by obtaining sensor data from sensors that are adapted to obtain information regarding the scene, in which a recording device may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor, an ultraviolet sensor, etc.), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the long-term storage (140) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the recording devices (e.g., 110A, 110N, etc.); (xii) provide automated data discovery, protection, management, and recovery operations for the clients; (xiii) monitor operational states of the clients; (xiv) regularly back up configuration information of the clients to the long-term storage (140); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or long-term storage; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120) may communicate with, for example, the long-term storage (140) and/or other storage devices in the system (100).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that the IN (120) may perform other functionalities without departing from the scope of the embodiments disclosed herein. In one or more embodiments, the IN may be configured to perform (in conjunction with the streaming storage system (125)) all, or a portion, of the functionalities described in FIGS. 2.1-2.3.

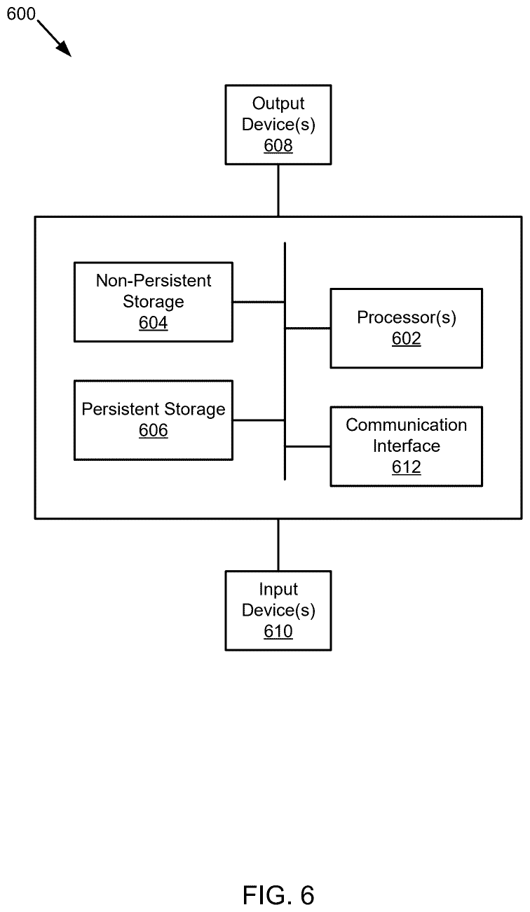

In one or more embodiments, the IN (120) may be implemented as a computing device (e.g., 600, FIG. 6). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (120) may also be implemented as a logical device.

In the embodiments of the present disclosure, the streaming storage system (125) is demonstrated as a separate entity from the IN (120); however, embodiments disclosed herein are not limited as such. The streaming storage system (125) may be demonstrated as a part of the IN (e.g., as deployed to the IN). Additional details of the streaming storage system are described below in reference to FIG. 2.

In the embodiments of the present disclosure, the long-term storage (140) is demonstrated as a separate entity from the IN (120); however, embodiments disclosed herein are not limited as such. The long-term storage (140) may be demonstrated as a part of the IN (e.g., as deployed to the IN). Additional details of the long-term storage are described below in reference to FIG. 2.

In one or more embodiments, all, or a portion, of the components of the system (100) may be operably connected to each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN (120), the long-term storage (140), the streaming storage system (125), etc.). As discussed above, components of the system (100) may operatively connect to one another through the network (e.g., a storage area network (SAN), a personal area network (PAN), a LAN, a metropolitan area network (MAN), a wireless area network (WAN), a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VOIP), etc.

Turning now to FIG. 2, FIG. 2 shows a diagram/architecture of the streaming storage system (125) in accordance with one or more embodiments disclosed herein. The streaming storage system (125) (e.g., Dell Pravega or simply “Pravega”) includes a segment store (SS) (202), a logger (206) (e.g., a bookkeeper service), a consensus service (208) (e.g., a zookeeper service), a video ingestion service (210), an orchestrator (212), and a video analytics service (214). The streaming storage system (125) may include additional, fewer, and/or different components without departing from the scope of the embodiments disclosed herein. For example, based on the amount of available computing resources in the IN (e.g., 120, FIG. 1), the streaming storage system (125) may host multiple orchestrators, segment containers (SCs) (e.g., 204A, 204B, etc.), and/or SSs executing contemporaneously, e.g., distributed across multiple servers, VMs, or containers, for scalability and fault tolerance. Each component may be operably connected to any of the other component via any combination of wired and/or wireless connections. Each component illustrated in FIG. 2 is discussed below.

The embodiment shown in FIG. 2 may show a scenario in which (i) one or more SCs (e.g., 204A, 204B, etc.) are distributed across the SS (202) and (ii) the streaming storage system (125) is an independent system (e.g., meaning that the streaming storage system may customize the resource usage of the SS independently, in an isolated manner).

In one or more embodiments, the streaming storage system (125) allows users (via clients (e.g., Client A (110A))) to ingest data and execute real-time analytics/processing on that data (while guaranteeing data consistency and durability (e.g., once acknowledged, data is never lost)). With the help of the SS (202), the data may be progressively moved to the long-term storage (140) so that users may have access to the data to perform large-scale batch analytics, for example, on a cloud (with more resources). Users may define clusters that execute a subset of assigned SCs across the system (e.g., 100, FIG. 1) so that different subsets of SCs may be executed on independent clusters (which may be customized in terms of instances and resources per-instance) to adapt different kinds of workloads and hardware components.

In one or more embodiments, the orchestrator (212) may represent a “control plane” and the SS (202), the video ingestion service (210), and the video analytics service (214) may represent a “data plane”. The SS (202) may execute/host, at least, SC A (204A) and SC B (204B) (as “active” SCs, so they may serve write/read operations), in which an SC is a unit of parallelism in Pravega (or a unit of work of a SS) and is responsible for executing any storage or metadata operations against the segments (described below) allocated in it. Further, the video analytics service (214) may perform some or all of the operations on video data received from the clients (e.g., recording device A (110A, FIG. 1)) as described in further detail below. Further, in one or more embodiments, the video analytics service (214) may be a separate service from the SS (202), or may be integrated into the SS (202) (e.g., via an SC). Due to the design characteristics of Pravega (e.g., with the help of the integrated storage tiering mechanism of Pravega), the SS (202) may store data to the long-term storage (140), in which the tiering storage may be useful to provide instant access to recent stream data. Although not shown, the streaming storage system may include one or more processors, buses, and/or other components without departing form the scope of the embodiments disclosed herein.

In one or more embodiments, an SC may represent how Pravega partitions a workload (e.g., a logical partition of the workload at the data plane) in order to host segments of streams. Once (automatically) initialized/initiated, an SC may keep executing on its corresponding SS (e.g., a physical component) to perform one or more operations, where, for example, Client A (110A) may not be aware of what the location of an SC in Pravega (e.g., in case Client A wants to generate a new stream with a segment).

In one or more embodiments, the control plane may include functionality to, e.g., in conjunction with the data plane, generate, alter, and/or delete streams; (ii) retrieve information about streams; and/or (iii) monitor health of a Pravega cluster (described below) by gathering metrics. Further, the SS (202) may provide an application programming interface (API) to read/write data in streams.

In one or more embodiments, a stream (described below) may be partitioned/decomposed into stream segments (or simply “segments”). A stream may have one or more segments (where each segment may be stored in a combination of tier-1 storage and tier-2 storage), in which data/event written into the stream may be written into exactly one of the segments based on the event's routing key. In one or more embodiments, writers (e.g., of Client A (110A)) may use routing keys (e.g., user identifier, timestamp, machine identifier, etc., to determine a target segment for a stream write operation) so that data is grouped together.

In one or more embodiments, based on the inherent capabilities of the streaming storage system (125) (e.g., Pravega), data streams may have multiple open segments in parallel (e.g., enabling the data stream parallelism), both for ingesting and consuming data. The number of parallel stream segments in a stream may automatically grow and shrink over time based on the input/output (I/O) load the stream receives, so that the parallelism of the stream may be modified based on the number of serverless functions to be executed, if needed.

In one or more embodiments, Client A (110A) may send metadata requests to the orchestrator (212) and may send data requests (e.g., write requests, read requests, create a stream, delete the stream, get the segments, etc.) to the SS (202). With respect to a “write path” (which is primarily driven by a sequential write performance of the orchestrator (212)), the writer component of Client A (110A) may first communicate with the orchestrator (212) to perform a write operation (e.g., appending events/data) and to infer which SS it supposed to connect to. Based on that, the writer component may connect to the SS (202) to start appending data. Thereafter, the SS (202) (more specifically, SCs hosted by the SS) may first write data (synchronously) to the logger (206) (e.g., the “tier-1 storage” of Pravega (which typically executes within the Pravega cluster), Apache Bookkeeper, a distributed write ahead log, etc.) to achieve data durability (e.g., in the presence of small write operations) and low-latency (e.g., <10 ms) before acknowledging the writer component on every data written (so that data may not be lost as data is saved in protected, persistent/temporary storage before the write operation is acknowledged).

Once acknowledged, in an offline process, the SS (202) may group the data (written to the logger (206) into larger chunks and asynchronously move the larger chunks to the long-term storage (140) (e.g., the “tier-2 storage” of Pravega, pluggable storage, AWS S3, Apache HDFS, Dell Isilon, Dell ECS, object storage, block storage, file system storage, etc.) for high read/write throughput (e.g., to perform batch analytics) (as indicated, Client A (110A) may not directly write to tier-2 storage) and for permanent data storage. For example, Client A may send a data request for storing and processing video data from a surgery in real-time (e.g., performing computations (or real-time analytics) on the video data captured by surgery cameras for providing augmented reality capabilities on the video data to help surgeons, where SC A (204A) may be used for this purpose), and eventually, this data may need to be available (or permanently stored) on a larger information technology (IT) facility that hosts enough storage/memory and compute resources (e.g., for executing batch analytics on historical video data to train ML models, where the video data may be asynchronously available in the tier-2 storage).

Further, with respect to a “read path” (which is isolated from the write path), the reader component of Client A (110A) may first communicate with the orchestrator (212) to perform a read operation and to infer which SS it is supposed to connect to (e.g., via its memory cache, the SS (202) may indicate where it keeps the data such that the SS may serve tail of data from the cache). For example, if the data is not cached (e.g., historical data), the SS may pull data from the long-term storage (140) so that the reader component performs the read operation (as indicated, the SS may not use the logger (206) to serve a read request of the reader component, where the data in the logger may be used for recovery purposes when necessary).

In one or more embodiments, once data is (and/or will be) provided by Client A (110A) to the SS (202), users may desire access to the data managed by the SS. To facilitate provisioning of access to the data, the SS may manage one or more data structures (in conjunction with the logger (206)), such as block chains, that include information, e.g.,: (i) related to data ownership, (ii) related to the data that is managed, (iii) related to users (e.g., data owners), and/or (iv) related to how users may access the stored data. In one or more embodiments, by providing data management services and/or operational management services (in conjunction with the logger) to the users and/or other entities, the SS may enable any number of entities to access data. As part of providing the data management services, the SS may provide (in conjunction with the logger and/or the long-term storage (140)) a secure method for storing and accessing data. By doing so, access to data in the logger may be provided securely while facilitating the provisioning of access to the data.

The data management services and/or operational management services provided by the SS (202) (through, for example, its SCs) may include, e.g.,: (i) obtaining data requests and/or data from Client A (110A) (where, for example, Client A performs a data write operation through a communication channel); (ii) organizing and/or writing/storing the “obtained” data (and metadata regarding the data) to the logger (206) to durably store the data; (iii) generating derived data based on the obtained data (e.g., grouping the data into larger chunks by employing a set of linear, non-linear, and/or ML models), (iv) providing/moving the obtained data, derived data, and/or metadata associated with both data to the long-term storage (140); (v) managing when, how, and/or what data Client A may provide; (vi) temporarily storing the obtained data in its cache for serving that data to reader components; and/or (vii) queueing one or more data requests.

In one or more embodiments, as being part of the tiered storage streaming system (e.g., tier-1 (durable) storage), the logger (206) may provide short-term, low-latency data storage/protection while preserving/guaranteeing the durability and consistency of data written to streams. In some embodiments, the logger may exist/execute within the Pravega cluster. As discussed above, the SS (202) may enable low-latency, fast, and durable write operations (e.g., data is replicated and persisted to disk before being acknowledged) to return an acknowledgement to a writer component (e.g., of Client A (110A)), and these operations may be optimized (in terms of I/O throughput) with the help of the logger.

In one or more embodiments, to add further efficiency, write operations to the logger (206) may involve data from multiple segments, so the cost of persisting data to disk may be amortized over several write operations. The logger may persist the most recently written stream data (to make sure reading from the tail of a stream can be performed as fast as possible), and as data in the logger ages, the data may be moved to the long-term storage (140) (e.g., a tail of a segment may be stored in tier-1 storage providing low-latency reads/writes, whereas the rest of the segment may be stored in tier-2 storage providing high-throughput read access with near-infinite scale and low-cost). Further, the Pravega cluster may use the logger as a coordination mechanism for its components, where the logger may rely on the consensus service (208).

One of ordinary skill will appreciate that the logger (206) may perform other functionalities without departing from the scope of the embodiments disclosed herein. The logger (206) may be implemented using hardware (e.g., any number of integrated circuits for processing computer readable instructions), software, or any combination thereof.

In one or more embodiments, in case of reads, SC A (204A) may have a “read index” that tracks the data read for the related segments, as well what fraction of that data is stored in cache. If a read process (e.g., initiated upon receiving a read request) requests data for a segment that is not cached, the read index may trigger a read process against the long-term storage (140) to retrieve that data, storing it in the cache, in order to serve Client A (110A).

As used herein, data may refer to a “stream data (or a “stream”)” that is a continuous (or continuously generated), unbounded (in size), append-only (e.g., data in a stream cannot be modified but may be truncated, meaning that segments are indivisible units that form the stream), lightweight (e.g., as a file), and durable sequence of bytes (e.g., a continuous data flow/structure that may include data, metadata, and/or the like; a collection of data records called “events”, in which there may not be a limit on how many events can be in a stream or how many total bytes are stored in a stream; etc.) generated (in parallel) by one or more data sources (e.g., 110A, 110N, IoT sensors, etc.). In one or more embodiments, by using append-only log data structures (which are useful for serverless computing frameworks while supporting real-time and historical data access), the SS (202) may enable rapid ingestion of information into durable storage (e.g., the logger (206)) and support a large variety of application use cases (e.g., publish/subscribe messaging, NoSQL databases, event-oriented applications, etc.). Further, a writer component may keep inserting events at one end of a stream and a reader component may keep reading the latest ones from there or for historical reads, the reader component may target specific offsets and keep reading from there.

As discussed above, Pravega (e.g., an open-source, distributed and tiered streaming storage system providing a cloud-native streaming infrastructure (i) that is formed by controller instances and SS instances, (ii) that eventually stores stream data in a long-term storage (e.g., 140), (iii) that enables auto-scaling of streams (where a degree of parallelism may change dynamically in order to react workload changes) and its connection with serverless computing, and (iv) that supports both a byte stream (allowing data to be access randomly by any byte offset) and an event stream (allowing parallel writes/reads)) may store and manage/serve data streams, in which the “stream” abstraction in Pravega is a first-class primitive for storing continuous and unbounded data. A data stream in Pravega guarantees strong consistency and achieves good performance (with respect to data storage and management), and may be combined with one or more stream processing engines (e.g., Apache Flink) to initiate streaming applications.

In one or more embodiments, the orchestrator (212) includes functionality to, e.g.,: (i) receive video quality SLAs (e.g., input-output (IO) metrics such as latency, throughput and queuing, resolution, bitrate, frames per second, video scale, encoding format, stream priority, etc.), (ii) continuously monitor performance metrics related to the video streams, (iii) instruct one or more processes (e.g., the SS (202) and/or the video ingestion service (210)) to adjust on or more video quality attributes for one or more of the video streams, (iv) collect historical information regarding the performance metrics related to the video streams, and/or (v) provide proactive, history-based video quality management.

One of ordinary skill will appreciate that the orchestrator (212) may perform other functionalities without departing from the scope of the embodiments disclosed herein. The orchestrator (212) may be implemented using hardware, software, or any combination thereof.

In one or more embodiments, the data plane may (i) collect video data from the recording devices (e.g., recording device A (110A, FIG. 1)), (ii) modify one or more video data attributes of the collected video data, (iii) write the collected video data to a storage system, and (iv) provide analytics based on the collected video data.

In one or more embodiments, the SS (202) includes functionality to, e.g., (i) manage the lifecycle of segments (where the SS may be unaware of streams but may store segment data); (ii) generate, merge, truncate, and/or delete segments, and serve read/write requests received from recording device A (110A, FIG. 1); (iii) use both a durable logger (e.g., 206) and the long-term storage (140) to store data and/or metadata; (iv) provide the video data to an analyzer (e.g., the video analytics service (214)) and/or provide analytics relating to the video data; (v) receive video data from a video ingestion service; and/or (vi) manage a data plane of the streaming storage (125) (e.g., implement read, write, and other data plane operations).

One of ordinary skill will appreciate that the SS (202) may perform other functionalities without departing from the scope of the embodiments disclosed herein. The SS (202) may be implemented using hardware, software, or any combination thereof.

In one or more embodiments, the video ingestion service (210) includes functionality to e.g., (i) receive one or more video streams from one or more clients (e.g., video recording devices); (ii) dynamically adjust one or more video data attributes for the one or more video streams; (iii) receive instructions to modify one or more video data attributes (e.g., via open port, topic subscription, etc.); (iv) write/store video data streams to the SS (202) or other storage systems (e.g., using methods described above); (v) determine the format and encoding format of the video data stream; and/or (v) make other modifications to the video data streams received from the clients.

One of ordinary skill will appreciate that the video ingestion service (210) may perform other functionalities without departing from the scope of the embodiments disclosed herein. Further, while a single video ingestion service (210) is illustrated as servicing multiple clients (i.e., in a one-to-many configuration), it should be appreciated that a separate video ingestion service may be provided for each client (i.e., in a one-to-one configuration). The video ingestion service (210) may be implemented using hardware, software, or any combination thereof.

In one or more embodiments, the video analytics service (214) includes functionality to e.g., provide any analytics of a video data stream including sending the data to other systems, preparing the video data for transit over a network, encrypting the video data, performing machine learning analysis such as object recognition, or any other action that may be performed with video data. One of ordinary skill will appreciate that the video analytics service (214) may perform other functionalities without departing from the scope of the embodiments disclosed herein. Further, while the video analytics service (214) is illustrated as being a part of the streaming storage system (125), the video analytics service (214) may be included as part of another system operatively connected to the streaming storage system (125). The video ingestion service (210) may be implemented using hardware, software, or any combination thereof.

In one or more embodiments, a consensus service may be required to have/keep a consistent view/state of a current SC distribution/assignment across the streaming storage systems (executing on the system (e.g., 100, FIG. 1)). For example, identifiers of SCs and their assignments may need to be consistent across the streaming storage systems and one way to achieve this is implementing the consensus service. To this end, the consensus service (208) (e.g., Apache Zookeeper) may include functionality to, e.g., (i) perform one or more coordination tasks (e.g., helping to the orchestrator (212) for the assignment/distribution of SCs to SS instances, helping a split of workloads across segments, etc.), and/or (ii) store no stream metadata.

One of ordinary skill will appreciate that the consensus service (208) may perform other functionalities without departing from the scope of the embodiments disclosed herein. The consensus service (208) may be implemented using hardware, software, or any combination thereof.

In one or more embodiments, SC A (204A) and SC B (204B) may allow users and/or applications to read/access data that was written in SC A and SC B and stored in the long-term storage (140) at the background. In one or more embodiments, SC A and SC B may be useful to perform an active-passive data replication. For example, SC A and SC B are writing data and at the same time, SS A and SS B may serve batch analytics tasks (e.g., batch reads) of data processing applications (of Client A (110A)) (for example, for a better user experience).

Further, the embodiment provided in FIG. 2 may utilize the inherent capabilities of the streaming storage system (125) deployed to the IN (e.g., 120, FIG. 1) to move data to the long-term storage (140) jointly with the SCs (e.g., 204A, 204B, etc.) as a form of active-passive data replication, which is useful for various different analytics workloads. For example, a user (of Client A (110A)) may perform real-time analytics on stream data (with the help of the logger (206), where the logger may persist the most recently written stream data) and at the same time, the related SCs (e.g., SC A, SC B, etc.) may move the data progressively to the long-term storage (140) (i) for serving batch reads/analytics at a later point-in-time (for example, upon receiving a batch read request from the user) and (ii) for enabling storage tiering capabilities provided by the streaming storage system (e.g., to perform active-passive data replication).

In one or more embodiments, as being part of the tiered storage streaming system (e.g., tier-2 storage), the long-term storage (140) may provide long-term (e.g., near-infinite retention), durable, high read/write throughput (e.g., to perform batch analytics; to perform generate, read, write, and delete operations; erasure coding; etc.) historical stream data storage/protection with near-infinite scale and low-cost. The long-term storage may be, for example (but not limited to): pluggable storage, AWS S3, Apache HDFS, Dell Isilon, Dell ECS, object storage, block storage, file system storage, etc. In one or more embodiments, the long-term storage (140) may be located/deployed outside of the streaming storage system (125), in which asynchronous migration of events from tier-1 storage to tier-2 storage (without affecting the performance of tail reads/writes) may reflect different access patterns to stream data.

In one or more embodiments, the long-term storage (140) may be a fully managed cloud (or local) storage that acts as a shared storage/memory resource that is functional to store unstructured and/or structured data. Further, the long-term storage (140) may also occupy a portion of a physical storage/memory device or, alternatively, may span across multiple physical storage/memory devices.

In one or more embodiments, the long-term storage (140) may be implemented using physical devices that provide data storage services (e.g., storing data and providing copies of previously stored data). The devices that provide data storage services may include hardware devices and/or logical devices. For example, the long-term storage (140) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the long-term storage (140) may include a memory device (e.g., a dual in-line memory device), in which data is stored and from which copies of previously stored data are provided. As yet another example, the long-term storage (140) may include a persistent storage device (e.g., an SSD), in which data is stored and from which copies of previously stored data is provided. As yet another example, the long-term storage (140) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the long-term storage (140) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

While the long-term storage (140) has been illustrated and described as including a limited number and type of data, the long-term storage (140) may store additional, less, and/or different data without departing from the scope of the embodiments disclosed herein. In the embodiments described above, the long-term storage (140) is demonstrated as a separate entity; however, embodiments herein are not limited as such. In one or more embodiments, the long-term storage (140) may be a part of the cloud.

One of ordinary skill will appreciate that the long-term storage (140) may perform other functionalities without departing from the scope of the embodiments disclosed herein. The long-term storage (140) may be implemented using hardware, software, or any combination thereof.

Turning now to FIG. 3, FIG. 3 shows a diagram of the orchestrator (212) in accordance with one or more embodiments. The orchestrator (212) may include a bitrate allocator (302), a scheduler (304), and a database (306). The orchestrator (212) may include additional, fewer, and/or different components without departing from the scope of the embodiments disclosed herein. Each component may be operably connected to any of the other component via any combination of wired and/or wireless connections. Each component illustrated in FIG. 3 is discussed below.

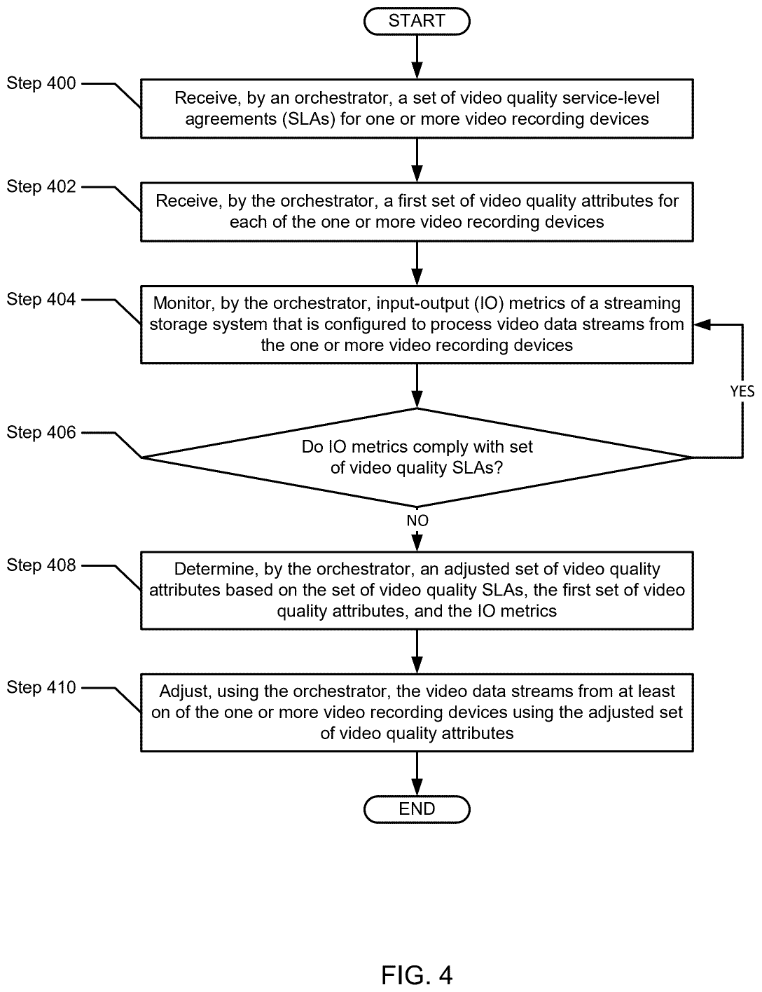

In one or more embodiments, bitrate allocator (302) includes functionality to manage the video data quality attributes of video data streams managed by the orchestrator in a reactive mode (e.g., the method of FIG. 4). In one or more embodiments, the bitrate allocator (302) is responsible for adjusting or causing an adjustment of video data quality attributes for one or more video data streams, as discussed in reference to FIG. 4 below. In one or more embodiments, the bitrate allocator (302) identifies the video data streams associated with the lowest tier of video quality SLAs and reduces the quality of those streams until the video data streams associated with higher tiers of video quality SLAs achieve the video quality attributes of their respective tier of video quality SLA.

In one or more embodiments, the bitrate allocator (302) considers more granularity with respect to the locations of where the video data streams are being sent and received. In a first example, if a first lower tier video data stream and a first higher tier video data stream are being ingested by a first location (e.g., segment store, video analytics service, server, etc.) and a second lower tier video data stream is being ingested by a second location, then the bitrate allocator (302) may only reduce the quality of the first lower tier video data stream until the first higher tier video data stream is in compliance with its data quality SLA, thereby leaving the second lower tier data stream unchanged. In a second example, if a first lower tier video data stream and a first higher tier video data stream are being ingested by a first location (e.g., segment store, video analytics service, server, etc.) and a second lower tier video data stream is being ingested by a second location, then the bitrate allocator (302) may cause the first lower tier video data stream to be ingested by the second location, thereby freeing up resources at the first location for the first higher tier video data stream.

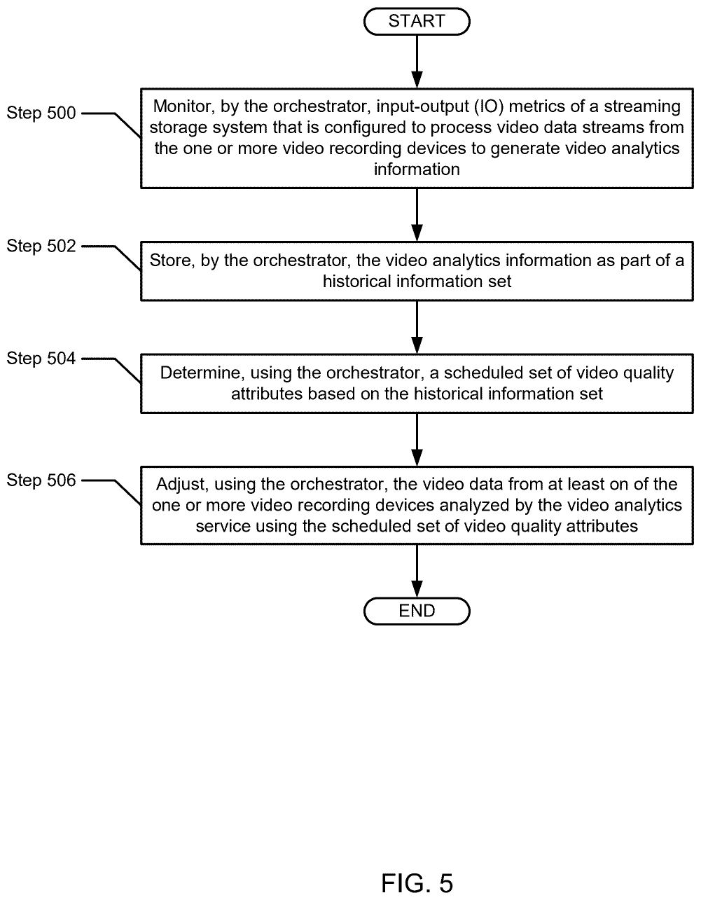

In one or more embodiments, the scheduler (304) includes functionality to manage the video data quality attributes of video data streams managed by the orchestrator in a proactive mode (e.g., the method of FIG. 5). In one or more embodiments, the scheduler (304) is responsible for adjusting or causing an adjustment of video data quality attributes for one or more video data streams, as discussed in reference to FIG. 5 below.

In one or more embodiments, the scheduler (304) provides functionality to (i) collect IO metrics, (ii) cleanse and normalize the IO metrics, (iii) perform a preliminary analysis to understand basic patterns in the IO metrics over time, (iv) select a model, (v) generate a model, and/or (vi) use a model. In one or more embodiments, the cleansing and normalizing of the IO metrics includes removing certain portions of the IO metrics, converting certain portions of the IO metrics to a standardized format, and/or adjusting the values of the IO metrics to a standardized scale to enable IO metrics across different formats and types to be analyzed together. In one or more embodiments, the preliminary analysis includes determining a basic chart of the IO metrics (e.g., what day, time of day, time of year, etc. do peaks occur and shapes of the IO metrics over time (sinusoidal, random, triangular, rectangular, etc.)).

In one or more embodiments, the model selected, generated, and/or used includes autoregressive integrated moving average, exponential smoothing or other deep learning model (described below).

In one or more embodiments, a DLM is a machine learning and/or artificial intelligence paradigm (e.g., a neural network, a decision tree, a support vector machine, etc.). Any DLM may be defined through a set of parameters and/or hyper-parameters that may be optimized or tuned to assure the optimal performance of a function—e.g., the mapping of a historical information set to a current data quality attribute set. A parameter may refer to a configuration variable that is internal to the DLM and whose value may be estimated from data. Examples of a parameter include, but are not limited to, the weights in a neural network, and the support vectors in a support vector machine. In contrast, a hyper-parameter may refer to a configuration variable that is external to the DLM and whose value may not be estimated from data. Examples of a hyper-parameter include, but are not limited to, the learning rate for training a neural network, and the soft margin cost function for a nonlinear support vector machine. Further, any DLM may be further defined through other architectural elements, which may vary depending on the paradigm based on which the DLM may be modeled.

For example, if a DLM follows a neural network design, other architectural elements that may be considered may include, but are not limited to: a number of layers, a number of nodes occupying each layer, an interconnectivity configuration between the various nodes, values for weights representative of the strengths of the various inter-nodal connections, propagation functions through which nodal outputs are computed with respect to nodal inputs and/or other parameters (e.g., weights), a specificity of a learning rule governing how the one or more parameters are adjusted to produce desired training results, etc. By way of another example, if a DLM follows a support vector machine design, other architectural elements that may be considered may alternatively include, but are not limited to: a number of support vectors defining hyperplane(s) that maximize the margins between classes, a kernel function for translating low dimensional input data into a higher dimensional space, a penalty value associated with an error term, a specificity of a kernel coefficient used for best-fitting the training data, etc.

In one or more embodiments, a DLM may be optimized through supervised learning. Supervised learning may refer to learning (or optimization) through the analyses of training examples and/or data. Substantively, through supervised learning, the various architectural elements (e.g., parameters, hyper-parameters, etc.) of a DLM may be adjusted through the successive feeding of training or sample node historical information. After each training or sample node historical information is fed into the DLM, which may be defined by various architectural elements set to specific values, an output (e.g., an adjusted set of data quality attributes) may be obtained. The obtained output may subsequently be compared to a desired output for the training or sample historical information that had been fed into the DLM for processing. Thereafter, the values associated with the various architectural elements are adjusted based on the comparison between the obtained output and the desired output in view of a specified optimization goal (e.g., the minimization of errors between the obtained output and the desired output) being met.

Further, in one or more embodiments, as each successive training or sample historical information is processed, the adjusted values of the various architectural elements may be carried over into the processing of the subsequent training or sample historical information, where the various architectural elements may be further adjusted until the specified optimization goal for the subsequent training or sample historical information is also met. In one or more embodiments, the training/sample historical information and corresponding desired outputs may be generated from any combination of data quality attributes collected over any span of time. One of ordinary skill will appreciate that other learning methodologies (e.g., unsupervised learning) may be used to optimize a DLM without departing from the scope provided herein.

In one or more embodiments, the model is stored and processed at a remote location and the scheduler (304) provides functionality to send the input (e.g., monitored video quality attributes) to the model and to receive and understand the output of the model to determine the adjusted set of video quality attributes.

In one or more embodiments, the database (306) stores all data utilized by the orchestrator (212), including data quality SLAs, IO metrics, data quality attributes, and/or historical information.

FIGS. 4-5 show a method for managing video data stream quality in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

FIG. 4 illustrates a method that may be considered reactive in that the method monitors various data streams and makes adjustments in reaction to characteristics of those data streams. In contrast, FIG. 5 illustrates a method that may be considered proactive in that the method analyzes historical information and generates a forward-looking schedule. In one or more embodiments, the method in FIG. 4 is a selectable reactive mode and the method in FIG. 5 is a selectable proactive mode. For example, an administrator may provide a selection to the orchestrator to operate in the reactive mode, the proactive mode, or both the reactive mode and the proactive mode.

Turning now to FIG. 4, the method shown in FIG. 4 may be executed by, for example, the above-discussed orchestrator (e.g., 212, FIG. 2). Other components of the streaming storage system (125) illustrated in FIG. 2 may also execute all or part of the method shown in FIG. 4 without departing from the scope of the embodiments disclosed herein.

In Step 400, the orchestrator receives a set of video quality SLAs for one or more video recording devices. In one or more embodiments, the orchestrator receives the set of video quality SLAs from a user input or from a remote location (e.g., a centralized server, a cloud service, etc.). As described above, the set of video quality SLAs may include service levels relating to throughput, latency, resolution, bitrate, frames per second, scale, and encoding formats. In one or more embodiments, each one or group of video recording devices are associated with different video quality SLAs. In one or more embodiments, the set of video quality SLAs includes different tiers (e.g., platinum, gold, silver, bronze, etc.) with each tier having an associated set of video qualities and/or priority level. Further, the lowest tier of video quality SLA may not include any specific target levels and instead may include best efforts available to the system.

In one non-limiting example, a first video data stream associated with a first recording device includes a gold tier set of video quality SLAs that includes a latency of 20 milliseconds and a second data stream associated with a second video recording device includes a silver tier of video quality SLAs that includes a latency of 40 millisecond. Further, in this example, if neither latency were achievable, then the latency of the first recording device would be prioritized over the latency of the second recording device.

In Step 402, the orchestrator receives a first set of video quality attributes for each of the one or more recording devices. In one or more embodiments, the first set of video quality attributes represents the current set of video quality attributes of the data streams associated with the one or more recording devices. In one or more embodiments, the video quality attributes include any qualities that are also included in the video quality SLAs, such as throughput, latency, resolution, bitrate, frames per second, scale, and encoding formats. The orchestrator may receive the first set of video quality attributes from a video ingestion service (e.g., 210, FIG. 2) and/or by sampling the data streams associated with the video recording devices.

In Step 404, the orchestrator monitors the IO metrics of a segment store (e.g., 202, FIG. 2) that is configured to process and/or direct the processing of video data streams from the one or more recording devices. As discussed above, the video recording devices record video data and send data streams of the video data (i.e., video data streams) to other locations such as the segment store, which may be directed and/or controlled by the video ingestion service. Then, the segment store may process the video data streams internally or send the video data streams to a video analytics service (e.g., 214, FIG. 2) to perform other processing actions on the video data streams and return the processed video data streams to the streaming storage system. The orchestrator may monitor the IO metrics as the video data streams are sent from the video recording devices to the segment store, as the video data streams are sent from the segment store to the video analytics service, as the video data streams are sent from the video analytics service to the segment store, or any combination thereof. Further, the IO metrics may include any qualities that are also included in the video quality SLAs, such as throughput, latency, resolution, bitrate, frames per second, scale, and encoding formats.

In Step 406, the orchestrator determines whether the IO metrics monitored in Step 404 comply with the set of video quality SLAs received in Step 400. If the IO metrics do comply with the set of video quality SLAs, then the method returns to Step 404 and continues to monitor the IO metrics to ensure that they continue to comply with the set of video quality SLAs. If the IO metrics do not comply with the set of video quality SLAs, then the method continues to Step 408.

In Step 408, the orchestrator determines an adjusted set of video quality attributes based on the set of video quality SLAs, the first set of video quality attributes, and the IO metrics. The adjusted set of video quality attributes may include adjustments for the video quality attributes for any number of appropriate video data streams, from a single video data stream to all of the available video data streams.

In Step 410, the orchestrator adjusts or causes an adjustment of one or more video data streams associated with the one or more using the adjusted set of video quality attributes. In one or more embodiments, the orchestrator sends the adjusted set of video quality attributes to the video ingestion service, which then adjusts the video quality attributes of the video data streams in accordance with the adjusted set of video quality attributes (e.g., by adjusting recording settings on the video recording devices themselves). In one or more embodiments, the orchestrator adjusts or causes to adjust (e.g., through an element or service between the segment store and video analytics service) the video quality attributes of the video data streams in accordance with the adjusted set of video quality attributes (e.g., by throttling video frames in terms of video quality, frames per second, discarding video frames, etc.).

In one or more embodiments, Steps 404 through Steps 410 are a recursive process to enable a continuous and/or near-continuous monitoring and adjustment of video quality attributes of video data streams. In one or more embodiments, the orchestrator identifies the video data streams associated with the lowest tier of video quality SLAs and reduces the quality of those streams until the video data streams associated with higher tiers of video quality SLAs achieve the video quality attributes of their respective tier of video quality SLA.

In one or more embodiments, the orchestrator considers more granularity with respect to the locations of where the video data streams are being sent and received. In a first example, if a first lower tier video data stream and a first higher tier video data stream are being ingested by a first location (e.g., segment store, video analytics service, server, etc.) and a second lower tier video data stream is being ingested by a second location, then the orchestrator may only reduce the quality of the first lower tier video data stream until the first higher tier video data stream is in compliance with its data quality SLA, thereby leaving the second lower tier data stream unchanged. In a second example, if a first lower tier video data stream and a first higher tier video data stream are being ingested by a first location (e.g., segment store, video analytics service, server, etc.) and a second lower tier video data stream is being ingested by a second location, then the orchestrator may cause the first lower tier video data stream to be ingested by the second location, thereby freeing up resources at the first location for the first higher tier video data stream.

The method may end following Step 410.

Turning now to FIG. 5, the method shown in FIG. 5 may be executed by, for example, the above-discussed orchestrator (e.g., 212, FIG. 2). Other components of the streaming storage system (125) illustrated in FIG. 2 may also execute all or part of the method shown in FIG. 5 without departing from the scope of the embodiments disclosed herein.

In Step 500, the orchestrator monitors the IO metrics of a segment store (e.g., 202, FIG. 2) that is configured to process and/or direct the processing of video data streams from the one or more recording devices to generate video analytics information. This Step 500 may include the same monitoring discuss in reference to Step 404.

In Step 502, the orchestrator stores or causes to store the video analytics information as part of a historical information set. In one or more embodiments, the orchestrator collects the video analytics information and sends it to a remote location (e.g., a centralized server, a cloud storage solution, etc.) to cause the video analytics information to be stored at the remote location. In one or more embodiments, the remote location may have additional resources and/or be operatively connected to multiple orchestrators to enable the remote location to provide additional storage and/or processing resources in addition to a greater set of data. Further, the historical information set may include prior-collected video analytics information collected by the orchestrator, synthetic data (e.g., data produced by a model trained using other data sets), information collected by other orchestrators, or any combination thereof.

In Step 504, the orchestrator determines a scheduled set of video quality attributes based on the historical information set. In one or more embodiments, this determination includes cleansing and normalizing the historical information set, performing an initial analysis to determine workload/IO metric patterns, selecting a model, training a model using the historical information set, and using the trained model to generate the scheduled set of video quality attributes. In one or more embodiments, the model is already trained and the historical information set is used as an input to generate the output, which includes the scheduled set of video quality attributes. More information regarding the model is discuss above.

In Step 506, the orchestrator adjusts or causes an adjustment of one or more video data streams associated with the one or more using the scheduled set of video quality attributes. The adjusting or causing an adjustment in this Step 506 may be performed in the same manner as in Step 410.

The method may end following Step 506.

Turning now to FIG. 6, FIG. 6 shows a diagram of a computing device in accordance with one or more embodiments disclosed herein.

In one or more embodiments disclosed herein, the computing device (600) may include one or more computer processors (602), non-persistent storage (604) (e.g., volatile memory, such as RAM, cache memory), persistent storage (606) (e.g., a non-transitory computer readable medium, a hard disk, an optical drive such as a CD drive or a DVD drive, a Flash memory, etc.), a communication interface (612) (e.g., Bluetooth interface, infrared interface, network interface, optical interface, etc.), an input device(s) (610), an output device(s) (608), and numerous other elements (not shown) and functionalities. Each of these components is described below.

In one or more embodiments, the computer processor(s) (602) may be an integrated circuit for processing instructions. For example, the computer processor(s) (602) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (e.g., a LAN, a WAN, Internet, mobile network, etc.) and/or to another device, such as another computing device.

In one or more embodiments, the computing device (600) may include one or more output devices (608), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a video quality, the method comprising:
receiving, at an orchestrator of a streaming storage system, a set of video quality service level agreements (SLAs) associated with the streaming storage system and a video recording device;
receiving, at the orchestrator, a set of current video quality attributes associated with the video recording device;
monitoring, via the orchestrator, an input-output metric of the streaming storage system configured to receive and process video data from the video recording device;
making, by the orchestrator, a first determination that the input-output metric does not comply with the set of video quality SLAs;
in response to the first determination, determining, by the orchestrator, an adjusted set of video quality attributes for the video recording device and based on the input-output metric, the set of video quality SLAs, and the current set of video quality attributes; and
adjusting, using the orchestrator, a set of video data from the video recording device that is received by a video analytics service using the adjusted set of video quality attributes.

2. The method of claim 1, wherein the video recording device comprises a plurality of video recording devices.

3. The method of claim 2, wherein adjusting the set of video data comprises adjusting video data associated with only one of the plurality of video recording devices.

4. The method of claim 2, wherein the plurality of video recording devices provide a closed-circuit television system.

5. The method of claim 1, wherein the method further comprises:
storing, using the orchestrator, a historical information set comprising a plurality of input-output metrics of the streaming storage system over a period of time;
determining, by the orchestrator, a scheduled set of video quality attributes based on the historical information set; and
adjusting, using the orchestrator, a second set of video data from the video recording device that is received by the video analytics service using the scheduled set of video quality attributes.

6. The method of claim 5, wherein the determining the scheduled set of video quality attributes comprises inputting the historical information set into a machine learning model and receiving the scheduled set of video quality attributes as an output of the machine learning model.

7. The method of claim 6, wherein the machine learning model is trained using the historical information set.

8. The method of claim 5, wherein the historical information set further comprises the set of video quality SLAs and the current set of video quality attributes.

9. A method for managing a video quality, the method comprising:
monitoring an input-output metric of a streaming storage system configured to receive and process video data;
making a first determination that the input-output metric does not comply with a set of video quality service level agreements (SLAs) associated with the streaming storage system;
in response to the first determination, making a second determination, based on the input-output metric and the set of video quality SLAs, an adjusted set of video quality attributes; and
in response to the second determination, adjusting a set of video data received by a video analytics service using the adjusted set of video quality attributes.

10. The method of claim 9, wherein the video data is from a video recording device, wherein the set of video quality SLAs are also associated with the video recording device.

11. The method of claim 10, wherein the video recording device comprises a plurality of video recording devices.

12. The method of claim 11, wherein adjusting the set of video data comprises adjusting video data associated with only one of the plurality of video recording devices.

13. The method of claim 11, wherein the plurality of video recording devices provide a closed-circuit television system.

14. The method of claim 9, wherein the method further comprises:
storing a historical information set comprising a plurality of input-output metrics of the streaming storage system over a period of time;
determining a scheduled set of video quality attributes based on the historical information set; and
adjusting a second set of video data from the video recording device that is received by the video analytics service using the scheduled set of video quality attributes.

15. The method of claim 14, wherein the determining the scheduled set of video quality attributes comprises inputting the historical information set into a machine learning model and receiving the scheduled set of video quality attributes as an output of the machine learning model.

16. The method of claim 15, wherein the machine learning model is trained using the historical information set.

17. The method of claim 14, wherein the historical information set further comprises the set of video quality SLAs.

18. A method for managing a video quality, the method comprising:
receiving, at an orchestrator of a streaming storage system, a set of video quality service level agreements (SLAs) associated with the streaming storage system and a video recording device;
receiving, at the orchestrator, a set of current video quality attributes associated with the video recording device;
monitoring, via the orchestrator, an input-output metric of the streaming storage system configured to receive and process video data from the video recording device;
storing, using the orchestrator, a historical information set comprising a plurality of input-output metrics of the streaming storage system over a period of time, wherein the historical information set is obtained during the monitoring;
determining, by the orchestrator, a scheduled set of video quality attributes based on the historical information set; and
adjusting, using the orchestrator, a second set of video data from the video recording device that is received by a video analytics service using the scheduled set of video quality attributes.

19. The method of claim 18, wherein the determining the scheduled set of video quality attributes comprises inputting the historical information set into a machine learning model and receiving the scheduled set of video quality attributes as an output of the machine learning model, and wherein the historical information set further comprises the set of video quality SLAs and the current set of video quality attributes.

20. The method of claim 19, wherein the machine learning model is trained using the historical information set.
